(19) United States
(12) Patent Application Publication
(10) Pub. No.: US 2011/0276249 A1
(43) Pub. Date: Nov. 10, 2011

(54) METHOD TO OPERATE AN ELECTRICALLY DRIVEN OPCJ VALVE OF AN INTERNAL COMBUSTION ENGINE

(75) Inventors: Roberto Argolini, Milan (IT); Davide Donna, Novara (IT); Morena Bruno, Chivasso (Torino) (IT)

(73) Assignee: GM GLOBAL TECHNOLOGY OPERATIONS LLC, Detroit, MI (US)

(21) Appl. No.: 13/099,075

(22) Filed: May 2, 2011

(30) Foreign Application Priority Data
May 10, 2010 (GB) 1007742.8

(51) Int. Cl. F02D 28/00

(52) U.S. Cl. 701/102

(57) ABSTRACT

A method is provided to operate an electrically driven OPCJ valve of an internal combustion engine that includes, but is not limited to cyclically performing a control method able to generate an opening request for the OPCJ valve, of opening (which includes, but is not limited to keeping opened the OPCJ valve), when the control method generates an opening request, and of closing (which includes, but is not limited to or keeping closed the OPCJ valve), when the control method does not generate an opening request. The control method comprises the steps of determining a value of a control parameter related to an engine torque, and of generating an opening request for the OPCJ valve, if the control parameter value exceeds a threshold value of the control parameter.

### CROSS-REFERENCE TO RELATED APPLICATION

This application claims priority to British Patent Application No. 1007742.8, filed May 10, 2010, which is incorporated herein by reference in its entirety.

### TECHNICAL FIELD

The technical field relates to a method for operating an electrically driven OPCJ valve of an internal combustion engine, typically an internal combustion engine of a motor vehicle.

### BACKGROUND

It is known that an internal combustion engine of a motor vehicle is provided with a lubrication system suitable for lubricating the rotating or sliding components of the engine. The lubrication system generally comprises an oil pump driven by the engine, which draws lubricating oil from a sump and delivers it under pressure through a main oil gallery that is realized in the engine cylinder block. This main oil gallery is connected via respective pipes to a plurality of exit holes for lubricating crankshaft bearings (main bearings and big-end bearings), camshaft bearings operating the valves, tappets, and the like.

In order to lubricate and cool the engine pistons, most internal combustion engines are also provided with an auxiliary oil gallery realized in the engine cylinder block, which is connected via respective pipes to a plurality of oil jets for squirting lubricating oil into an upper crankcase area towards piston surfaces. The auxiliary oil gallery is connected to the main oil gallery via a feeding line equipped with a valve for selectively open or close said feeding line, which is commonly defined as squirters valve or Oil Piston Cooling Jets (OPCJ) valve.

When the OPCJ valve is open, the lubricating oil is delivered under pressure to the oil jets and then squirted towards the engine pistons. When the OPCJ valve is closed, the lubricating oil remains into the auxiliary gallery, so that no lubrication and cooling of the engine pistons is achieved.

Traditionally, the OPCJ valve is a mechanical valve which is automatically driven by the pressure of the lubricating oil inside the main oil gallery. As a matter of fact, the mechanical OPCJ valve automatically opens when the value of the pressure inside the main gallery exceeds a certain threshold of said pressure. However, this behavior may cause the mechanical OPCJ valve to open also when not needed or vice versa, thereby increasing fuel consumption and polluting emissions. In order to overcome this and other drawbacks, the mechanical OPCJ valve has been generally replaced by an electrically driven OPCJ valve, which is commanded by an engine control unit (ECU).

Therefore, at least one object is to provide a strategy able to manage the operation of an electrically driven OPCJ valve, so as to optimize both the cooling and the lubrication of the engine pistons, thereby reducing fuel consumption and polluting emissions. At least another object is to reach this goal with a simple, rational and rather inexpensive solution. In addition, other objects, desirable features and characteristics will become apparent from the subsequent summary and detailed description, and the appended claims, taken in conjunction with the accompanying drawings and this background.

### SUMMARY

An embodiment provides a method to operate an electrically driven OPCJ valve of an internal combustion engine, comprising the general steps of: cyclically performing a control procedure able to generate an opening request for the OPCJ valve, opening or keeping opened the OPCJ valve, when the control procedure generates an opening request, and closing or keeping closed the OPCJ valve, when the control procedure does not generate an opening request. As a matter of fact, if an opening request is generated while the OPCJ valve is already open, the method provides for keeping the OPCJ valve open; if conversely the opening request is generated while the OPCJ valve is currently closed, the method provides for switching the OPCJ valve to open. Likewise, if an opening request is not generated while the OPCJ valve is currently open, the method provides for switching the OPCJ valve to close; if conversely an opening request is not generated while the OPCJ valve is already closed, the method provides for keeping the OPCJ valve closed.

According to this embodiment, the control method comprises the steps of: determining a value of a control parameter related to an engine torque, and generating an opening request for the OPCJ valve, if the control parameter value exceeds a threshold value of the control parameter. By managing the operation of the OPCJ valve on the basis of the engine torque, this method is advantageously able to optimize both the cooling and the lubrication of the engine pistons, thereby reducing fuel consumption and polluting emissions.

According to an embodiment, the control parameter can be a Brake Mean Effective Pressure (BMEP). The BMEP pressure is a parameter which is generally calculated by the ECU also for other managing purposes, so that this aspect of the invention provides a reliable way to determine the engine torque, without any additional effort.

According to an embodiment, the threshold value of the control parameter is determined as a function of a approximate value of the control parameter, which is determined on the basis of an engine speed value. In this way, the method is able to account for different operating conditions of the engine.

According to an embodiment, the approximate value of the control parameter is determined by means of an empirically determined map correlating the approximate value to the engine speed value. In this way, the map can be determined during an experimental activity and then stored in a data carrier connected to the ECU, thereby allowing the determination of the approximate value with a minimum of computational effort.

According to another embodiment, the threshold value of the control parameter is determined by correcting the approximate value of the control parameter with a correction factor, which is determined as a function of a value of a parameter correlated to the thermal state of the engine. This embodiment increases the robustness of the threshold value. Moreover, by defining the threshold value of the engine torque on the basis of both the engine speed and the thermal state of the engine, this embodiment of the invention implicitly accounts for the engine power and for the exhaust gas temperature.

According to an embodiment, the parameter correlated to the thermal state of the engine is chosen from: lubricating oil temperature and coolant temperature. As a matter of fact, the ECU of the modern engines are already provided for measuring or estimating the temperature of the lubricating oil or the temperature of the engine coolant, so that this aspect of the invention allows a reliable determination of the thermal state of the engine without additional cost.

According to an embodiment, the control method comprises the further steps of: counting a duration of a closure period in which the OPCJ valve remains closed, and generating an opening request for the OPCJ valve, if the closure period duration exceeds a threshold duration of the closure period. This embodiment advantageously guarantees piston lubrication also when the torque limit criteria does not generate any opening request for a long time, thereby preventing the piston seizure.

According to an embodiment, the control method comprises the further step of continuing to generate the opening request for a predetermined time, after the duration of the closure period has exceeded its threshold. This allows an effective lubrication of the pistons.

According to another embodiment, the control method comprises the further steps of: determining a value of an engine metal temperature, generating an opening request for the OPCJ valve, if the engine metal temperature value exceeds a threshold value of the engine metal temperature. The engine metal temperature is defined as the temperature of a material part of the engine, such as for example the engine block or the cylinder head. The advantageously provides at least substantially continuous lubrication and cooling of the pistons, in case of an engine overheating. The engine metal temperature can be measured by means of a dedicated sensor, which is generally already present on most modern combustion engines.

According to still another embodiment of the invention, the control method comprises the further steps of: determining a value of an electrical parameter related to a charging level of a battery supplying the OPCJ valve, generating an opening request for the OPCJ valve, if the electrical parameter value is below a threshold value of the electrical parameter. As a matter of fact, the OPCJ valve requires an electrical supply, in order to be closed and kept closed, while it does not requires any electrical supply, in order to be opened and kept opened. As a consequence, this embodiment allows minimizing the current absorption when the battery is at a low charging status, so as to preserve the operation of most important devices of the internal combustion engine.

According to an embodiment, the electrical parameter is a battery voltage. As a matter of fact, the battery voltage is a parameter which is generally easily available.

The method according can be carried out with a computer program comprising a program-code for carrying out all the steps of the method described above, and in the form of a computer program product comprising the computer program. The computer program product can be embodied as an internal combustion engine equipped with an OPCJ valve, an ECU connected to the OPCJ valve, a data carrier associated to the ECU, and the computer program stored in the data carrier, so that, when the ECU executes the computer program, all the steps of the method described above are carried out.

The method can be also embodied as an electromagnetic signal, said signal being modulated to carry a sequence of data bits which represent a computer program to carry out all steps of the method.

### BRIEF DESCRIPTION OF THE DRAWINGS

The present invention will hereinafter be described in conjunction with the following drawing figures, wherein like numerals denote like elements, and:

FIG. 1 is a schematic representation of a lubrication system of a multi-cylinder internal combustion engine;

FIG. 2 is a flowchart representing a method according to an embodiment; and

FIG. 3 is a flowchart representing a subroutine for determining a threshold value of the engine torque, employed in the method according to an embodiment.

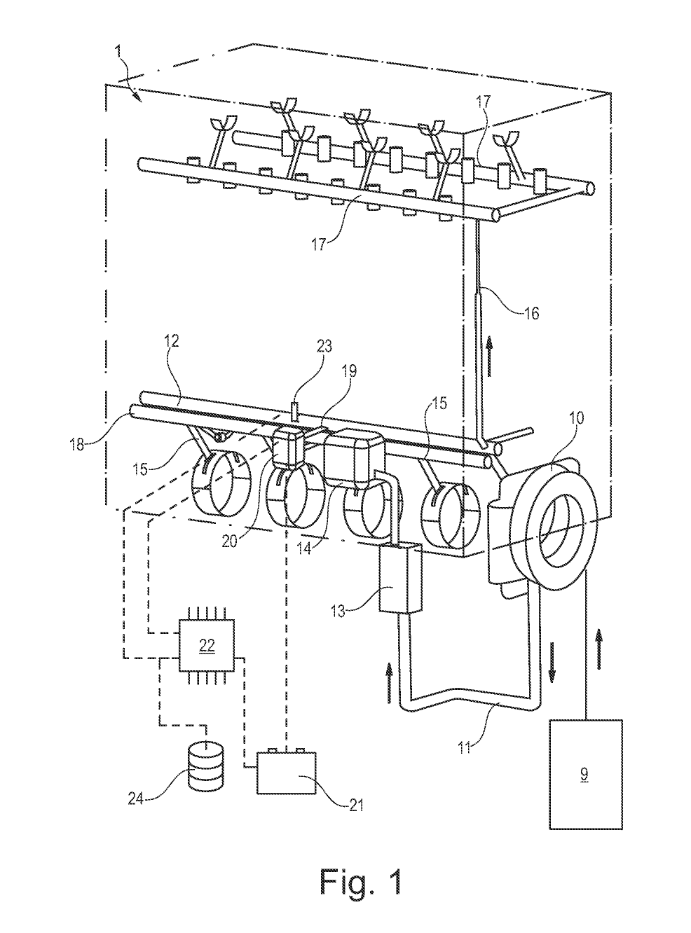

### DETAILED DESCRIPTION

The following detailed description is merely exemplary in nature and is not intended to limit application and uses. Furthermore, there is no intention to be bound by any theory presented in the preceding background or summary or the following detailed description.

An embodiment is hereinafter disclosed referring to an internal combustion engine 1, which is schematically represented in dash-dot line. The internal combustion engine 1 can be either a spark ignition engine as well as a Diesel engine. The internal combustion engine 1 is equipped with a lubrication system comprising a Variable Displacement Oil Pump (VDOP) 10 driven by the engine, which draws lubricating oil from a sump 9 and delivers it under pressure through a feeding line 11 to a main oil gallery 12 in the engine cylinder block.

During the normal operation of the engine, the VDOP 10 can be commanded in order to selectively change its state from an high displacement configuration to a low displacement configuration or vice versa, thereby causing a significant variation of the pressure of the lubricating oil into the main oil gallery 12. The feeding line 11 is further provided with an oil cooler 13 and with an oil filter 14, for respectively cooling and filtering the lubricating oil flowing therein.

The main oil gallery 12 is connected via respective pipes 15 to a plurality of exit holes for lubricating crankshaft bearings (main bearings and big-end bearings). Through a head supply pipe 16 and a plurality of connecting pipes 17, the main oil gallery 12 is further connected to a plurality of exit holes for lubricating the camshaft bearings operating the valves, tappets, and the like.

In order to cool the engine pistons, the engine lubrication system comprises an auxiliary oil gallery 18 in the engine cylinder block, which is connected via respective pipes to a plurality of oil jets (not shown) for squirting lubricating oil into an upper crankcase area towards piston surfaces. The auxiliary oil gallery 18 is connected to the main oil gallery 12 via a feeding line 19. An electrically driven Oil Piston Cooling Jets (OPCJ) valve 20 is located in the feeding line 19, in order to selectively open and close the passageway from the main oil gallery 12 and the auxiliary oil gallery 18.

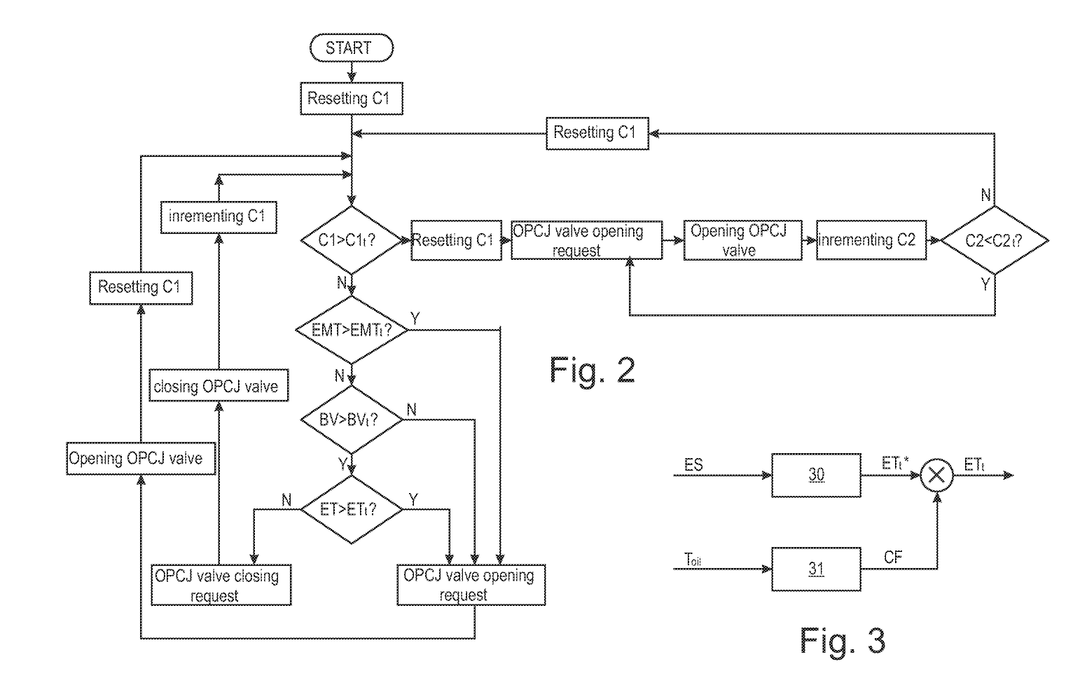

The OPCJ valve 20 is electrically supplied by a battery 21, which is also provided for supply other electrically driven devices of the internal combustion engine 1, such as for example the VDOP 10. In greater detail, the valve is electrically powered so as to be closed or kept closed, while the OPCJ valve 20 automatically opens and remains open when it is not electrically powered. The electrical supply of the OPCJ valve 20 is governed by en engine control unit (ECU) 22, according to a dedicated method for operating the OPCJ valve 20, which is schematically represented in the flowchart of FIG. 2.

The very first step of this method provides for resetting the value C1 of a counter, which is used for counting the duration of a period in which the OPCJ valve 20 is kept closed. After this first step, the method provides for performing an iterative control method.

This iterative control firstly provides for evaluating if the duration C1 exceeds a preset threshold duration C1t for the period in which the OPCJ valve is kept closed. The threshold duration C1t can be empirically determined as the maximum time during which the engine pistons can be not lubricate, without risking piston seizure. If the duration C1 does not exceed the threshold duration C1t, the control procedure provides for determining the value EMT of an engine metal temperature, and for evaluating if this value EMT exceeds a preset threshold value EMTt of the engine metal temperature. The value EMT can be measured by means of a dedicated sensor associated to the internal combustion engine 1. The threshold value EMTt can be empirically determined as the engine metal temperature above which the internal combustion engine 1 is overheated. If the value EMT exceeds the threshold value EMTt, the control procedure provides for generating an opening request for the OPCJ valve 20.

Following this OPCJ valve opening request, the control procedure provides for actually opening the OPCJ valve. As a matter of fact, to open the OPCJ valve 20 means to keep the OPCJ valve 20 opened, if the OPCJ valve is already opened, or alternatively to switch the OPCJ valve 20 to open, if the OPCJ valve 20 is currently closed. Afterwards, the duration C1 is reset and the control method is repeated as shown by the arrow in FIG. 2.

If conversely the value EMT does not exceed the threshold value EMTt, the control procedure provides for determining the value BV of the voltage of the battery 21, and for evaluating if this value BV exceeds a preset threshold value BVt of the battery voltage. The value BV can be determined by the ECU 22 connected to the battery 21. The threshold value BVt can be empirically determined as the battery voltage below which it is advisable to not electrically supply the OPCJ valve 20, so as to reduce the current absorption and to ensure the operation of most important electrical devices of the internal combustion engine 1.

If the value BV does not exceed the threshold value BVt, the control procedure provides for generating an opening request for the OPCJ valve 20, and to perform the same subsequent steps described above, as shown by the arrows in FIG. 2. If conversely the value BV exceeds the threshold value BVt, the control procedure provides for determining the value ET of a parameter correlated to the torque generated by the internal combustion engine 1, and for evaluating if this value ET exceeds a predetermined threshold value ETt of said parameter correlated to the engine torque.

The parameter correlated to the engine torque can be the Brake Mean Effective pressure (IMEP), and its value ET can be determined by the ECU 22. The threshold value ETt is determined during each iteration of the control procedure, according to a subroutine that is represented in FIG. 3. As a matter of fact, the determination of the threshold value ETt comprises the step of determining the value ES of the engine speed and the value Toil of the temperature of the lubricating oil inside the lubricating system.

The engine speed value ES is determined by means of an encoder (not shown) associated to the crankshaft of the internal combustion engine 1, which is connected to the ECU 22. The oil temperature value Toil is determined by means of a temperature sensor 23 located in the main oil gallery 12, which is connected to the ECU 22. The engine speed value ES is applied to an empirically determined map 30 correlating the engine speed value ES to a rough threshold value ETt* of the engine torque parameter. The rough threshold value ETt* is then multiplied by a correction factor CF, in order to determine the final threshold value ETt of the engine torque parameter. The correction factor CF is calculated by means of a calculation module 31, as a function of the oil temperature value Toil.

If the value ET exceeds the threshold value ETt, the control procedure provides for generating an opening request for the OPCJ valve 20, and to perform the same subsequent steps described above, as shown by the arrows in FIG. 2. If conversely the value ET does not exceed the threshold value ETt, the control procedure provides for generating a closing request for the OPCJ valve 20. Following this OPCJ valve closing request, the control procedure provides for actually closing the OPCJ valve. As a matter of fact, to close the OPCJ valve 20 means to keep the OPCJ valve 20 closed, if the OPCJ valve is already closed, or alternatively to switch the OPCJ valve 20 to close, if the OPCJ valve 20 is currently open.

Subsequently, the duration C1 is incremented and the control procedure is repeated as shown by the arrow in FIG. 2. It may happen that the control procedure returns an OPCJ valve closing request for a plurality of consecutive iterations, so that the OPCJ valve 20 is kept closed for a continuous period, whose duration is counted by the increasing duration C1. If the duration C1 exceeds the threshold duration C1t, the control procedure generally provides for opening the OPCJ valve 20 and for subsequently keep the OPCJ valve 20 opened for a determined time, in order to ensure the lubrication of the engine pistons so as to prevent piston seizure.

In greater details, the control method provides for resetting the value C2 of a second counter, which is used to count the duration of time in which the OPCJ valve 20 will remain open. Afterwards, the control procedure provides for generating an opening request for the OPCJ valve 20. Following this OPCJ valve opening request, the control procedure provides for actually opening the OPCJ valve and for incrementing the duration C2. Afterwards, the control procedure provides for evaluating if the duration C2 exceeds a predetermined set point duration C2t for the period in which the OPCJ valve must be kept open.

The set point duration C2t can be constant or can be determined as a function of the engine speed. If the duration C2 does not exceed the threshold duration C2t, the control procedure provides for repeating the OPCJ valve request, so as to actually keep the OPCJ valve 20 open. When the duration C2 exceeds the threshold duration C2t, the duration C1 is reset and the control procedure is repeated as shown by the arrow in FIG. 2.

This method for operating the OPCJ valve 20 can be managed with the help of a computer program comprising a program-code for carrying out all the steps described above. The computer program is stored in a data carrier 24 associated to the ECU 22. In this way, when the ECU 22 executes the computer program, all the steps of the embodiments of the method described above are carried out.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method to operate an electrically driven OPCJ valve of an internal combustion engine, comprising:
cyclically performing a control method configured to generate an opening request for the electrically driven OPCJ valve);
opening the electrically driven OPCJ valve when the control method generates the opening request; and
closing the electrically driven OPCJ valve when the control method does not generate the opening request;
wherein the control method comprises:
determining a control parameter related to an engine torque; and
generating the opening request for the electrically driven OPCJ valve if the control parameter exceeds a threshold value of the control parameter.

2. The method according to claim 1, wherein the control parameter is a Brake Mean Effective Pressure.

3. The method according to claim 1, further comprising determining the threshold value of the control parameter as a function of an approximate value of the control parameter that is determined on a basis of an engine speed value.

4. The method according to claim 3, further comprising determining the approximate value of the control parameter with an empirically determined map correlating the approximate value to the engine speed value.

5. The method according to claim 3, further comprising determining the threshold value of the control parameter by correcting the approximate value of the control parameter with a correction factor that is determined as a second function of a value of a parameter correlated to a thermal state of the internal combustion engine.

6. The method according to claim 5, further comprising selecting the parameter correlated to the thermal state of the internal combustion engine from a first temperature and a second temperature

7. The method according to claim 6, wherein the first temperature is a lubricating oil temperature.

8. The method according to claim 6, wherein the first temperature is a coolant temperature.

9. The method according to claim 1, wherein the control method further comprises:
counting a duration of a closure period in which the electrically driven OPCJ valve remains closed; and
generating the opening request for the electrically driven OPCJ valve if the duration exceeds a threshold duration of the closure period.

10. The method according to claim 9, wherein the control method further comprises continuing to generate the opening request for a predetermined time after the duration of the closure period has exceeded the threshold duration.

11. The method according to claim 1, wherein the control method further comprises:
determining a value of an engine metal temperature,
generating the opening request for the electrically driven OPCJ valve if the engine metal temperature exceeds a threshold value of the engine metal temperature.

12. The method according to claim 1, further comprising:
determining a value of an electrical parameter related to a charging level of a battery supplying electrically driven OPCJ valve; and
generating the opening request for the electrically driven OPCJ valve if the electrical parameter is below a threshold value of the electrical parameter.

13. The method according to claim 12, wherein the electrical parameter is a battery voltage.

14. A computer readable medium embodying a computer program product, said computer program product comprising:
a program to operate an electrically driven OPCJ valve of an internal combustion engine, program configured to:
cyclically perform a control program configured to generate an opening request for the electrically driven OPCJ valve;
open the electrically driven OPCJ valve when a control method generates the opening request; and
close the electrically driven OPCJ valve when the control method does not generate the opening request;
wherein the control program configured to:
determine a value of a control parameter related to an engine torque; and
generate the opening request for the Electrically driven OPCJ valve if the control parameter exceeds a threshold value of the control parameter.

15. The computer readable medium embodying the computer program product according to claim 14, wherein the control parameter is a Brake Mean Effective Pressure.

16. The computer readable medium embodying the computer program product according to claim 14, the program further configured to determine the threshold value of the control parameter as a function of a approximate value of the control parameter that is determined on a basis of an engine speed value.

17. The computer readable medium embodying the computer program product according to claim 14, wherein the control program is further configured to:
count a duration of a closure period in which the Electrically driven OPCJ valve remains closed; and
generate the opening request for the Electrically driven OPCJ valve if the duration exceeds a threshold duration of the closure period.

18. The computer readable medium embodying the computer program product according to claim 14, wherein the control method further configured to:
determine an engine metal temperature,
generate the opening request for the Electrically driven OPCJ valve if the engine metal temperature exceeds a threshold value of the engine metal temperature.

19. The computer readable medium embodying the computer program product according to claim 14, the program further configured to:
determine a value of an electrical parameter related to a charging level of a battery supplying the electrically driven OPCJ valve; and
generate the opening request for the Electrically driven OPCJ valve if the electrical parameter is below a threshold value of the electrical parameter.

20. An internal combustion engine, comprising:
an electrically driven OPCJ valve; and
an ECU connected to the Electrically driven OPCJ valve, the ECU configured to:
cyclically perform a control program configured to generate an opening request for the electrically driven OPCJ valve;
open the electrically driven OPCJ valve when a control method generates the opening request; and
close the electrically driven OPCJ valve when the control method does not generate the opening request;
wherein the control program configured to:
determine a value of a control parameter related to an engine torque; and
generate the opening request for the Electrically driven OPCJ valve if the control parameter exceeds a threshold value of the control parameter.

21. The internal combustion engine according to claim 20, wherein the control parameter is a Brake Mean Effective Pressure.

22. The internal combustion engine according to claim 20, the ECU is further configured to determine the threshold value of the control parameter as a function of a approximate value of the control parameter that is determined on a basis of an engine speed value.

23. The internal combustion engine according to claim 20, wherein the ECU is further configured to:
count a duration of a closure period in which the Electrically driven OPCJ valve remains closed; and
generate the opening request for the Electrically driven OPCJ valve if the duration exceeds a threshold duration of the closure period.

24. The internal combustion engine according to claim 20, wherein the control method is further configured to:
determine a an engine metal temperature,
generate the opening request for the Electrically driven OPCJ valve if the engine metal temperature exceeds a threshold value of the engine metal temperature.

25. The internal combustion engine according to claim 20, the ECU is further configured to:
determine a value of an electrical parameter related to a charging level of a battery supplying the Electrically driven OPCJ valve; and
generate the opening request for the Electrically driven OPCJ valve if the electrical parameter is below a threshold value of the electrical parameter.
